(19) United States
(12) Patent Application Publication
(10) Pub. No.: US 2025/0254137 A1
(43) Pub. Date: Aug. 7, 2025

(54) LOW LATENCY COMMUNICATION CHANNEL OVER A COMMUNICATIONS BUS USING A HOST CHANNEL ADAPTER

(71) Applicant: MELLANOX TECHNOLOGIES, LTD., Yokneam (IL)

(72) Inventors: Roman Nudelman, Kiryat Bialik (IL); Eliav Bar-Ilan, Or Akiva (IL); Alexander Mikheev, Hadera (IL)

(21) Appl. No.: 18/432,986

(22) Filed: Feb. 5, 2024

(51) Int. Cl. H04L 49/356; G06F 13/16

(52) U.S. Cl. CPC H04L 49/358; G06F 13/1668

(57) ABSTRACT

Embodiments of the present disclosure are directed to utilizing a Host Channel Adapter (HCA) to facility low latency intra-node communications over a communications bus such as a Peripheral Component Interconnect express (PCIe) bus, for example. Generally speaking, hardware devices coupled with the communications bus can write short, “doorbell” messages to the HCA. The messages can indicate tasks to be performed by another device also coupled with the communications bus. The HCA in turn can write a Completion Queue Entry (CQE) based on the received message to a Completion Queue (CQ) of the other device. The other device can then read the CQE from the CQ and perform the indicated task.

### FIELD OF THE DISCLOSURE

The present disclosure is generally directed to low latency communications over a communications bus and more particularly to utilizing a Host Channel Adapter to facility low latency communications.

### BACKGROUND

Within a computing systems, various devices and resources communicate utilizing a communications bus interconnecting these various devices. One example of such a communication bus is the Peripheral Component Interconnect express (PCIe) bus which can be used by devices such as Data Processing Units (DPUs), Central Processing Units (CPUs), Graphics Processing Units (GPUs), or other device to support intra-node communications.

In some cases, these intra-node communications utilize Queue Pairs (QPs) between the devices. However, using such QPs increases the overhead and latency for these intra-node communications. Latency, especially when higher than and additive too the latency of the communication bus itself, can be significant. For example, such latency can reduce the benefits of offloading workloads to other devices. Additionally, such latencies make many-to-one communication inefficient. Hence, there is a need in the art for improved methods and systems for supporting low latency communications over a communications bus.

### BRIEF SUMMARY

Embodiments of the present disclosure are directed to utilizing a Host Channel Adapter (HCA) to facility low latency intra-node communications over a communications bus such as a Peripheral Component Interconnect express (PCIe) bus, for example. Generally speaking, hardware devices coupled with the communications bus can write short, “doorbell” messages to the HCA. The messages can indicate tasks to be performed by another device also coupled with the communications bus. The HCA in turn can write a Completion Queue Entry (CQE) based on the received message to a Completion Queue (CQ) of the other device. The other device can then read the CQE from the CQ and perform the indicated task.

According to one embodiment, a first device can comprise a control circuit controlling operation of the device. The control circuit can be provided on a Data Processing Unit (DPU), a Central Processing Unit (CPU), a Graphics Processing Unit (GPU), or other device. When the device is coupled with a communications bus, the control circuit can cause the device to write, via the communications bus, a message to an HCA coupled with the communications bus. The message can comprise a predetermined number of bytes indicating a request for one or more tasks to be performed by a second device coupled with the communications bus. The message can comprise a pointer to a memory address, code, a counter, a notification, etc. The second device can comprise a DPU, a CPU, a GPU, or other device coupled with the communications bus.

According to another embodiment, an HCA can comprise a control circuit controlling operation of the HCA. When the HCA is coupled with a communications bus, the control circuit can cause the HCA to receive, via the communications bus, a message from a first device coupled with the communications bus. The message can be, for example, 4 to 8 bytes in length. The message can indicate a request from the first device for one or more tasks to be performed by a second device coupled with the communications bus.

The control circuit controlling the HCA can further cause the HCA to write a CQE based on the received message to a CQ of the second device via the communications bus. In some cases, writing the CQE to the CQ of the second device can comprise concatenating together a plurality of messages and writing the concatenated messages to the CQ of the second device.

The control circuit controlling the HCA can further cause the HCA to receive messages from a plurality of devices coupled with the communications bus and write a CQE for each received message into the CQ of the second device. The first device can be one of the plurality of devices. In such cases, the CQE can comprise a different address for each of the plurality of devices.

According to yet another embodiment, a system can comprise a communications bus and a first device coupled with the communications bus. For example, the communications bus can comprise a PCIe bus. The first device can comprise a control circuit controlling operation of the first device. An HCA can also be coupled with the communications bus and can comprise a control circuit controlling operation of the HCA. A second device can also be coupled with the communications bus and can comprise a control circuit controlling operation of the second device. The first and second devices can comprise any of a DPU, a CPU, a GPU, and/or other device.

The control circuit controlling operation of the first device can cause the first device to write a message to the HCA via the communications bus. The message can be, for example, 4 to 8 bytes in length. The message can indicate a request for one or more tasks to be performed by the second device.

The control circuit controlling operation of the HCA can cause the HCA to receive the message from the first device via the communications bus and write a CQE based on the received message to a CQ of the second device via the communications bus.

The control circuit controlling operation of the second device can cause the second device to read the CQE from the CQ of the second device and perform the one or more tasks. In some cases, the CQE can comprise a plurality of messages concatenated together. Additionally, or alternatively, the CQ of the second device stores CQEs from a plurality of devices coupled with the communications bus and the first device can be one of the plurality of devices.

Additional features and advantages are described herein and will be apparent from the following Detailed Description and the figures.

### BRIEF DESCRIPTION OF THE SEVERAL VIEWS OF THE DRAWINGS

The present disclosure is described in conjunction with the appended figures, which are not necessarily drawn to scale.

FIG. 1 is a block diagram illustrating an exemplary environment in which embodiments of the present disclosure can be implemented.

FIG. 2 is a block diagram illustrating an exemplary exchange of low latency communications on a communications bus according to one embodiment of the present disclosure.

FIG. 3 is a flowchart illustrating an exemplary process for initiating low latency communications according to one embodiment of the present disclosure.

FIG. 4 is a flowchart illustrating an exemplary process for handling low latency communications according to one embodiment of the present disclosure.

FIG. 5 is a flowchart illustrating an exemplary process for completing low latency communications according to one embodiment of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the described embodiments. It is understood that various changes may be made in the function and arrangement of elements without departing from the spirit and scope of the appended claims.

It will be appreciated from the following description, and for reasons of computational efficiency, that the components of the system can be arranged at any appropriate location within a distributed network of components without impacting the operation of the system.

Furthermore, it should be appreciated that the various links connecting the elements can be wired, traces, or wireless links, or any appropriate combination thereof, or any other appropriate known or later developed element(s) that is capable of supplying and/or communicating data to and from the connected elements. Transmission media used as links, for example, can be any appropriate carrier for electrical signals, including coaxial cables, copper wire and fiber optics, electrical traces on a printed circuit board (PCB), or the like.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “automatic” and variations thereof, as used herein, refers to any appropriate process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not to be deemed “material.”

The terms “determine,” “calculate,” and “compute,” and variations thereof, as used herein, are used interchangeably, and include any appropriate type of methodology, process, operation, or technique.

Various aspects of the present disclosure will be described herein with reference to drawings that are schematic illustrations of idealized configurations.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and this disclosure.

As used herein, the singular forms “a,” “an,” and “the” are intended to include the plural forms as well, unless the context clearly indicates otherwise. It will be further understood that the terms “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. The term “and/or” includes any and all combinations of one or more of the associated listed items.

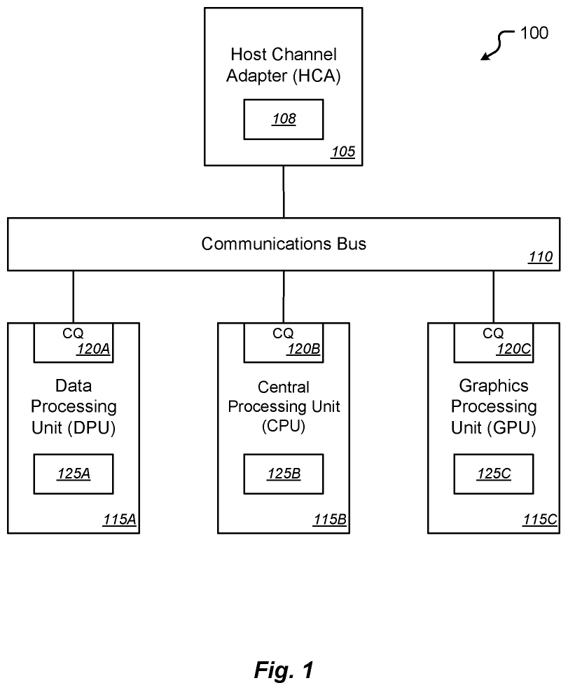

Referring now to FIGS. 1-5, various systems and methods for low latency communications over a communications bus will be described. More specifically, embodiments of the present disclosure are directed to utilizing a Host Channel Adapter (HCA) to facility low latency intra-node communications over a communications bus such as a Peripheral Component Interconnect express (PCIe) bus, for example. Generally speaking, hardware devices coupled with the communications bus can write short, “doorbell” messages to the HCA. The messages can indicate tasks to be performed by another device also coupled with the communications bus. The HCA in turn can write a Completion Queue Entry (CQE) based on the received message to a Completion Queue (CQ) of the other device. The other device can then read the CQE from the CQ and perform the indicated task.

FIG. 1 is a block diagram illustrating an exemplary environment in which embodiments of the present disclosure can be implemented. As illustrated in this example, the environment 100 can comprise an HCA 105. The HCA 105 can comprise a control circuit 108 controlling operation of the HCA 105. Control circuit 108 of the HCA 105 may be provided as silicon, as a Field Programmable Gate Array (FPGA), an Application-Specific Integrated Circuit (ASIC), any other type of Integrated Circuit (IC) chip, a collection of IC chips, or the like. As a more specific example, the control circuit 108 may be provided as a microprocessor or plurality of microprocessors that are configured to execute the instructions sets stored in a memory. Execution of the instruction sets stored in the memory enables various functions of the HCA 105.

The HCA 105 can be coupled with a communications bus 110. The communications bus 110 can comprise, for example, a PCIe bus or similar bus as known in the art. The communications bus 110 can comprise circuitry (not shown here) supporting intra-node communications between a number of devices 115A-115C also coupled with the communication bus 110.

The devices 115A-115C coupled with the communications bus 110 can include, but are not limited to, a Data Processing Unit (DPU), a Central Processing Unit (CPU), a Graphics Processing Unit (GPU), and/or other devices as known in the art. Each device 115A-115C can further comprise a CQ 120A-120C and a control circuit 125A-125C. As known in the art, CQs 120A-120C can hold events that indicate the completion of data transfer operations. Each CQ 120A-120C can be associated with a channel that created the queue. Therefore, while only one CQ 120A-120C per device 115A-115C is shown here for the sake of explanation, it should be understood that each device 115A-115C can and likely will have more than one CQ. It should be noted that, while the HCA 105 and DPU 115A are illustrated here as separate elements for the sake of explanation, these elements may be combined in the same physical component. For example, the HCA 105 may be implemented as part of, i.e., within, the DPU 115A.

The control circuit 125A-125C of each device 115A-115C may be provided as silicon, as a Field Programmable Gate Array (FPGA), an Application-Specific Integrated Circuit (ASIC), any other type of Integrated Circuit (IC) chip, a collection of IC chips, or the like. As a more specific example, the control circuit 125A-125C of any of the devices 115A-115C may be provided as a microprocessor or plurality of microprocessors that are configured to execute the instructions sets stored in a memory. Execution of the instruction sets stored in the memory enables various functions of each device 115A-115C.

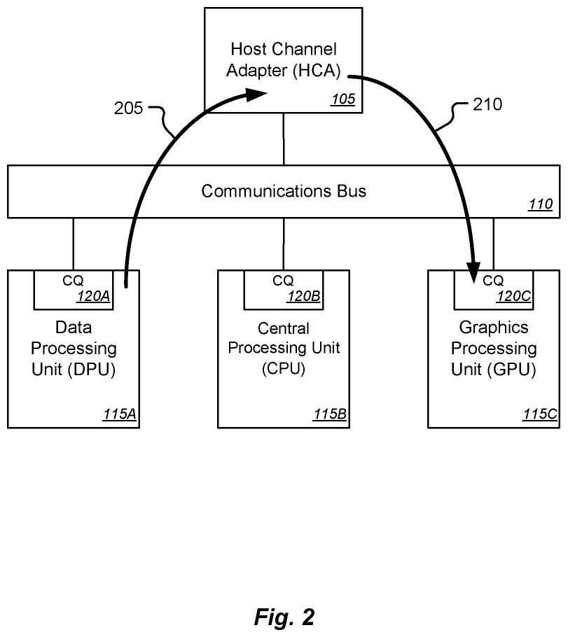

FIG. 2 is a block diagram illustrating an exemplary exchange of low latency communications on a communications bus according to one embodiment of the present disclosure. Generally speaking, and as illustrated in this example, one of the devices, i.e., a first device 115A or requestor device, can send a message 205 to the HCA 105 via the communications bus 110 and the HCA 105 can in turn write a CQE 210 to the CQ 120C of another of the devices, i.e., a second device 115C or target device.

More specifically, the control circuit 125A of the first device 115A can cause the first device 115A to write, via the communications bus 110, a message 205 to the HCA 105. The message can comprise a predetermined number of bytes, e.g., 4-8 bytes, indicating a request for one or more tasks to be performed by a second device 115C coupled with the communications bus 110. The message 205 can comprise a pointer to a memory address, code, a counter, a notification, etc.

The control circuit 108 of the HCA 105 can cause the HCA 105 to receive, via the communications bus 110, the message 205 from a first device 115A. The control circuit 108 controlling the HCA 105 can further cause the HCA to generate CQE 210 based on the received message. The CQE can comprise an address, e.g., an address associated with the first device 115A from which the message 205 was received. Since the HCA can receive messages 205 from any of the devices 115A-115C on the communications bus 110, the HCA 105 can assign different address for each of the plurality of devices 115A-115C when receiving messages 205 from the devices 115A-115C. In some cases, generating and writing the CQE 210 to the CQ 120C of the second device 115C can comprise concatenating together a plurality of messages 205 and writing the concatenated messages 205 to the CQ 120C of the second device 115C.

The control circuit 108 of the HCA 105 can cause the HCA 105 to then write the CQE 210 to a CQ of the second device 115C via the communications bus 110. As noted above, the communications bus 110 can comprise a PCIe bus. In such cases, and according to one embodiment, a PCIe Base Address Register (BAR) of the second device 115C can be used as the CQ 120C for that device 115C. The control circuit 125C controlling operation of the second device 115C can cause the second device 115C to read the CQE 210 from the CQ 120C of the second device 115C and perform the one or more tasks.

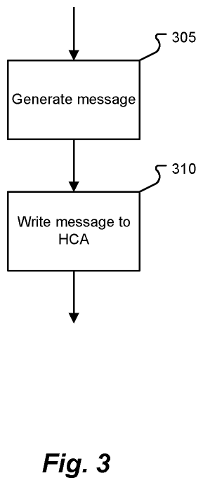

FIG. 3 is a flowchart illustrating an exemplary process for initiating low latency communications according to one embodiment of the present disclosure. More specifically, this example illustrates processes as may be performed by a first device 115A, i.e., a requestor device, as described above. As illustrated in this example, the process can comprise generating 305 a message 205 and writing 310 the message 205 to the HCA 105 via the communications bus 110. As noted, the message 205 can indicate tasks to be performed by another device also coupled with the communications bus. The message 205 can comprise a short, e.g., 4-8 bytes, “doorbell” message. The message 205 can comprise a pointer to a memory address, code, a counter, a notification, etc.

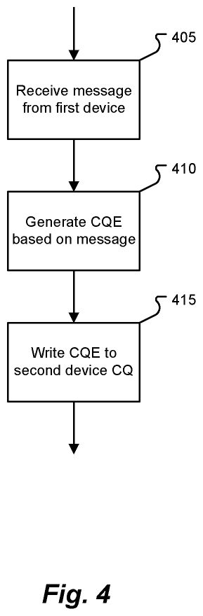

FIG. 4 is a flowchart illustrating an exemplary process for handling low latency communications according to one embodiment of the present disclosure. More specifically, this example illustrates processes as may be performed by an HCA 105 as described above. As illustrated in this example, the process can comprise receiving 405 a message 205 from a first device 115A via the communications bus 110. From this message 205, a CQE 210 can be generated 410. In such cases, the CQE 210 can comprise a different address for each of the plurality of devices. In some cases, the CQE 210 can comprise a plurality of messages concatenated together. The generated 410 CQE 210 can then be written 415 to the CQ 120C of the second device 115C via the communications bus 110. As noted, the CQ 120C of the second device 115C can store CQEs from a plurality of devices 115A-115C coupled with the communications bus 110 and the first device 115A can be one of the plurality of devices 115A-115C.

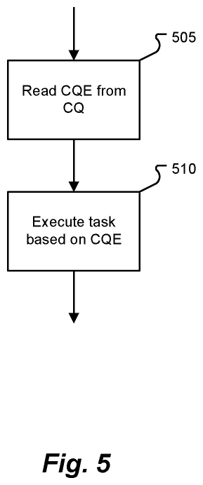

FIG. 5 is a flowchart illustrating an exemplary process for completing low latency communications according to one embodiment of the present disclosure. More specifically, this example illustrates processes as may be performed by a second device 115C, i.e., a target device, as described above. As illustrated in this example, the process can comprise reading 505 the CQE 210 from the CQ 120C and executing 510 a task associated with the CQE 210. For example, and as described above, the CQE 210 can comprise an address, e.g., in the memory of the first device 115A, i.e., the requestor device, or elsewhere. Such an address can store, for example, data to be read, instructions to be executed, etc.

Specific details were given in the description to provide a thorough understanding of the embodiments. However, it will be understood by one of ordinary skill in the art that the embodiments may be practiced without these specific details. In other instances, well-known circuits, processes, algorithms, structures, and techniques may be shown without unnecessary detail in order to avoid obscuring the embodiments.

While illustrative embodiments of the disclosure have been described in detail herein, it is to be understood that the inventive concepts may be otherwise variously embodied and employed, and that the appended claims are intended to be construed to include such variations, except as limited by the prior art. It is to be appreciated that any feature described herein can be claimed in combination with any other feature(s) as described herein, regardless of whether the features come from the same described embodiment.

What is claimed is:

1. A first device comprising:
a control circuit controlling operation of the device, wherein, when the device is coupled with a communications bus, the control circuit causes the device to:
write, via the communications bus, a message to a Host Channel Adapter (HCA) coupled with the communications bus, wherein the message comprises a predetermined number of bytes indicating a request for one or more tasks to be performed by a second device coupled with the communications bus.

2. The device of claim 1, wherein the control circuit is provided on a Data Processing Unit (DPU).

3. The device of claim 1, wherein the control circuit is provided on a Central Processing Unit (CPU).

4. The device of claim 1, wherein the control circuit is provided on a Graphics Processing Unit (GPU).

5. The device of claim 1, wherein the message comprises a pointer to a memory address.

6. The device of claim 1, wherein the message comprises code.

7. The device of claim 1, wherein the message comprises a counter.

8. The device of claim 1, wherein the message comprises a notification.

9. A Host Channel Adapter (HCA) comprising:
a control circuit controlling operation of the HCA, wherein, when the HCA is coupled with a communications bus, the control circuit causes the HCA to:
receive, via the communications bus, a message from a first device coupled with the communications bus, the message indicating a request from the first device for one or more tasks to be performed by a second device coupled with the communications bus; and
write a Completion Queue Entry (CQE) based on the received message to a Completion Queue (CQ) of the second device via the communications bus.

10. The HCA of claim 9, wherein the message is 4 to 8 bytes in length.

11. The HCA of claim 10, wherein writing the CQE to the CQ of the second device comprises concatenating together a plurality of messages and writing the concatenated messages to the CQ of the second device.

12. The HCA of claim 9, wherein the control circuit controlling the HCA further causes the HCA to receive messages from a plurality of devices coupled with the communications bus and write a CQE for each received message into the CQ of the second device, wherein the first device is one of the plurality of devices and wherein the CQE comprises a different address for each of the plurality of devices.

13. A system comprising:
a communications bus;
a first device coupled with the communications bus, the first device comprising a control circuit controlling operation of the first device;
a Host Channel Adapter (HCA) coupled with the communications bus, the HCA comprising a control circuit controlling operation of the HCA; and
a second device coupled with the communications bus, the second device comprising a control circuit controlling operation of the second device, wherein:
the control circuit controlling operation of the first device causes the first device to write a message to the HCA via the communications bus, the message indicating a request for one or more tasks to be performed by the second device,
the control circuit controlling operation of the HCA causes the HCA to receive the message from the first device via the communications bus and write a Completion Queue Entry (CQE) based on the received message to a Completion Queue (CQ) of the second device via the communications bus, and
the control circuit controlling operation of the second device causes the second device to read the CQE from the CQ of the second device and perform the one or more tasks.

14. The system of claim 13, wherein the communications bus comprises a Peripheral Component Interconnect express (PCIe) bus.

15. The system of claim 14, wherein the first device comprises a Data Processing Unit (DPU).

16. The system of claim 14, wherein the first device comprises a Central Processing Unit (CPU).

17. The system of claim 14, wherein the control circuit is provided on a Graphics Processing Unit (GPU).

18. The system of claim 13, wherein the message is 4 to 8 bytes in length.

19. The system of claim 18, wherein the CQE comprises a plurality of messages concatenated together.

20. The system of claim 13, wherein the CQ of the second device stores CQEs from a plurality of devices coupled with the communications bus and wherein the first device is one of the plurality of devices.
